(19) United States
(12) Patent Application Publication
(10) Pub. No.: US 2013/0043367 A1
(43) Pub. Date: Feb. 21, 2013

(54) Weight Balance Module and Gravity Center Adjustable Storage Device Using the Same

(71) Applicants: Ho-Ching Huang, Taipei City (TW); Hui-Chen Wang, Taipei City (TW); Yi-Chun Tang, Taipei City (TW)

(72) Inventors: Ho-Ching Huang, Taipei City (TW); Hui-Chen Wang, Taipei City (TW); Yi-Chun Tang, Taipei City (TW)

(73) Assignee: PEGATRON CORPORATION, Taipei City (TW)

(21) Appl. No.: 13/572,939

(22) Filed: Aug. 13, 2012

(30) Foreign Application Priority Data
Aug. 15, 2011 (TW) 100129023

(51) Int. Cl. F16M 13/00

(52) U.S. Cl. 248/364

(57) ABSTRACT

A weight balance module and a gravity center adjustable storage device using the same are provided. The weight balance module is disposed on a bottom face of a storage device and includes a balance plate and at least one balance piece. The balance plate has a plurality of predefined areas. The balance piece is selectively disposed on one of the plurality of the predefined areas.

### BACKGROUND

1. Technology Field

This disclosure generally relates to a weight balance module and a gravity center adjustable storage device using the same.

2. Description of the Prior Art

With the progress of information technology, the use of computers is very popular. Besides being used in the indoor space, computers are also used in transportation means, such as cars and boats. One the other hand, the software and information accessed by the computer are mostly stored in a hard drive. Therefore, the hard drive can be seen as the most important data storage device for computers. However, frequent and irregular vibrations usually occur when transportation means are running or moving. A disk error or computer crash caused by vibrations is easily happened if no proper fixing device is applied to the hard drive.

In general, the resonance frequency of a hard drive is above 100-200 Hz. As the prior art shown in FIG. 1, for a passive vibration isolation system to decrease the delivery of an external vibration, a balance plate 30 is usually fixed on the hard drive 10 to increase the weight of hard drive, wherein the resonance frequency is therefore lowered to enhance the vibration isolation performance. However, the spindle motors of the hard drives manufactured by different manufactures are often disposed at different locations. As a result, increasing the weight of hard drives by using the balance plate 30 may raise a problem of gravity center deviation. On the other hand, the cost will be increased if the balance plate is customized in accordance with the location of spindle motor of the hard drives manufactured by different manufactures.

### SUMMARY

It is an object of the present invention to provide a weight balance module and a gravity center adjustable storage device using the same, wherein the weight balance module increases the shake endurance of the storage device and decreases the disk error or computer crash caused by vibrations and reduces the situation of gravity center deviation. In other words, the gravity center adjustable storage device using the weight balance module has better shake endurance and has a mass center closer to its geometric center.

The embodiment of the present invention provides a weight balance module and a gravity center adjustable storage device using the same. The weight balance module is disposed on a bottom face of a storage device and includes a balance plate and at least one balance piece. The balance plate has a plurality of predefined areas. The balance piece is selectively disposed on one of the plurality of the predefined areas.

The balance plate of the embodiment has a plurality of partition lines for defining the plurality of predefined areas. The plurality of predefined areas are identical in shape and area. The balance piece has a cross section, which is identical to the predefined area in shape and area. Each predefined area has a screw hole; the balance piece has a fixing hole; the balance is disposed on the predefined area by making a screw pass through the fixing hole and be screwed into the screw hole.

The gravity center adjustable storage device of the embodiment includes the storage device and the weight balance module. The gravity center of the gravity center adjustable storage device is located on the central normal of the bottom face when the balance piece is disposed on a selected one of the plurality of the predefined areas.

### BRIEF DESCRIPTION OF THE DRAWINGS

FIG. 1 is a schematic view of the prior art;

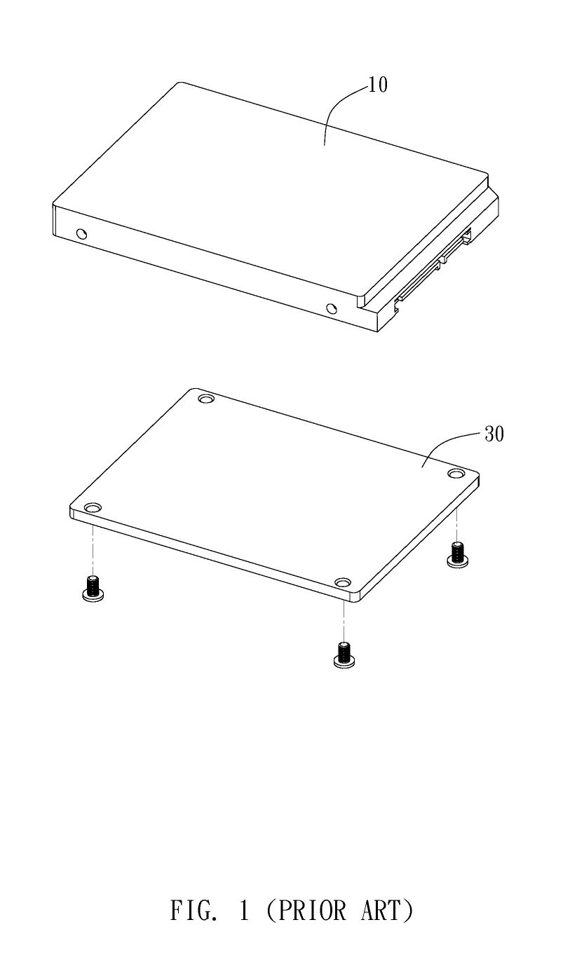

FIG. 2 is an explosive diagram of the preferred embodiment of the present invention;

FIG. 3 is a bottom view of the preferred embodiment of the present invention; and

FIG. 4 is a bottom view of a different embodiment of the present invention.

### DETAILED DESCRIPTION OF THE PREFERRED EMBODIMENT

The weight balance module of the present invention is for use with a storage device to constitute a gravity center adjustable storage device. The gravity center adjustable storage device is for use with a computer. In the preferred embodiment, the computer is disposed on transportation means. More particularly, the gravity center adjustable storage device of present invention is for use with a computer disposed on a vehicle. In other embodiments, however, the computer can be placed in a static environment and is not limited to be connected to transportation means. In addition to vehicles, the transportation means also include boats and aircrafts.

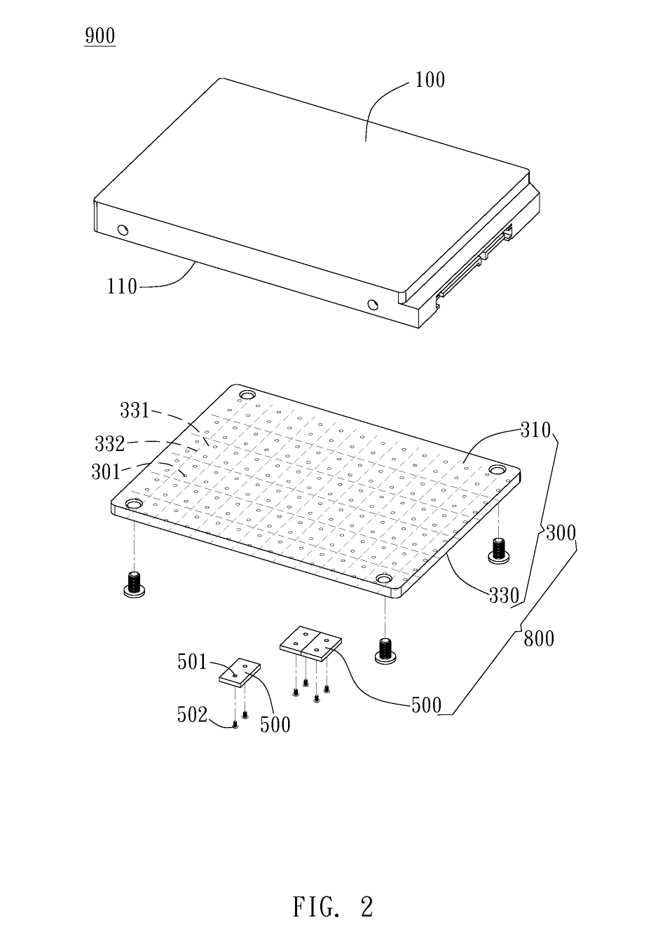

As the explosive diagram shown in FIG. 2, the weight balance module 800 of the present invention includes a balance plate 300 and at least one balance piece 500. The weight balance module 800 can be further used with the storage device 100 to constitute a gravity center adjustable storage device 900. More particularly, the balance plate 300 is disposed on a bottom face 110 of the storage device 100. In the preferred embodiment, the balance plate 300 is identical to the bottom face 110 in shape and area, wherein the balance plate 300 overlaps the bottom face 110. The balance plate 300 preferably includes a connecting face 310 facing the bottom face 100 and a balancing face 330 disposed on the opposite side with respect to the connecting face 310.

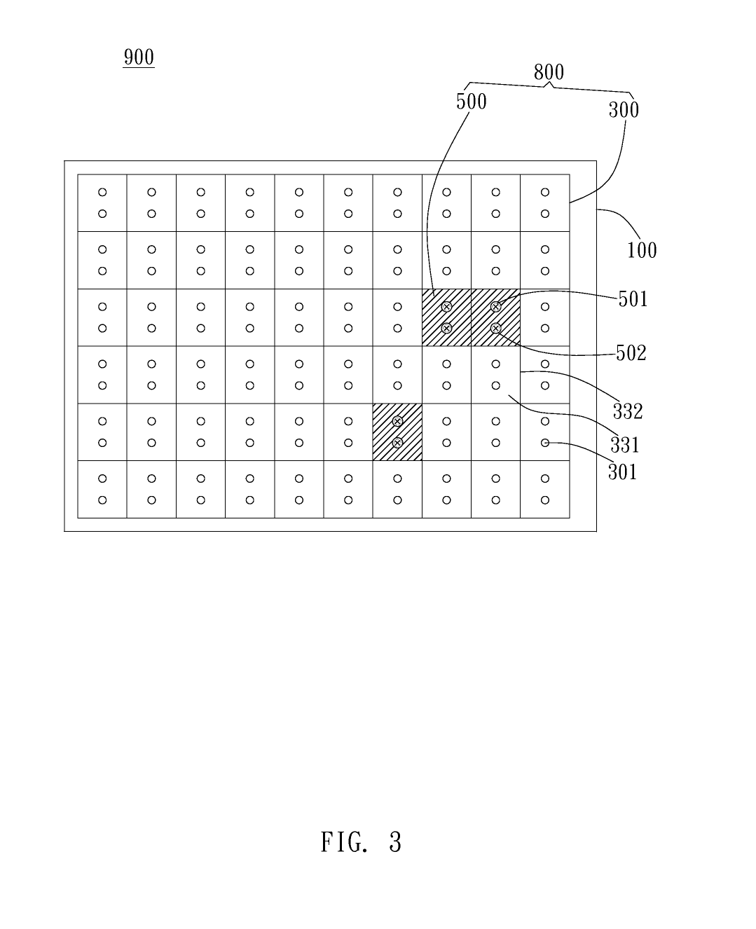

As the bottom view of the preferred embodiment shown in FIG. 3, the balancing face 330 of the balance plate 300 has a plurality of predefined areas 331.

The balance piece 500 is selectively disposed on one of the plurality of predefined areas 331. Moreover, the balancing face 330 has a plurality of partition lines 332 for defining the plurality of predefined areas 331, i.e. the partition line 332 is disposed between adjacent predefined areas 331. Based on the demand, the number of the balance piece 500 can be one or more than one. Since the balance piece(s) 500 can be disposed on the selected one(s) of the plurality of predefined areas 331, the gravity center of the gravity center adjustable storage device 900 can be adjusted by changing the location of the balance piece 500 and hence reduces the situation of gravity center deviation happened on the gravity center adjustable storage device 900. In other words, the gravity center adjustable storage device 900 has better shake endurance and has a mass center closer to its geometric center. In the preferred embodiment, the gravity center of the gravity center adjustable storage device 900 is located on the central normal of the bottom face 110 when the balance piece 500 is disposed on one of the plurality of the predefined areas 331. In a different embodiment, however, the gravity center of the gravity center adjustable storage device 900 is near the central normal of the bottom face 110, such as the mapping region of the center block of a 3 by 3 grid of the bottom face 110, when the balance piece 500 is disposed on one of the plurality of the predefined areas 331.

Each predefined area 331 preferably has a screw hole 301; the balance piece 500 has a fixing hole 501. As such, the balance piece 500 can be disposed/fixed on the predefined area 331 by a screw 502, which passes through the fixing hole 501 and is screwed into the screw hole 301. In a different embodiment, however, the balance piece 500 can be disposed on the predefined area 331 by other means. For example, a pin can be disposed on the balance piece 500 to be inserted into and fixed in a hole disposed on the predefined area 331. Also, sliding rims can be disposed on the balance piece 500 to be inserted into sliding chutes disposed on the balancing face 330, wherein the balance piece 500 is therefore can be slidably disposed to any desirable predefined area 331. Moreover, the balance plate 300 can be a frame having a plurality of windows to serve as the predefined areas 331 so that the balance piece 500 can be selectively embedded into any desirable window.

In the preferred embodiment, the plurality of predefined areas 331 are identical in shape and area, wherein the cross section of the balance piece 500 is identical to the predefined area 331 in shape and area. In other words, the balance piece 500 overlaps the predefined area 331 without crossing the partition line 332 when the balance piece 500 is disposed on the predefined area 331. Accordingly, the balance piece 500 having a cross section with identical shape and area can be arbitrarily disposed on any desirable predefined area 331 in accordance with the demand. The cost can be reduced since the balance piece 500 can be made in uniform specification. On the other hand, the shape and the area of the plurality of predefined areas 331 can be changed in accordance with the design requirement.

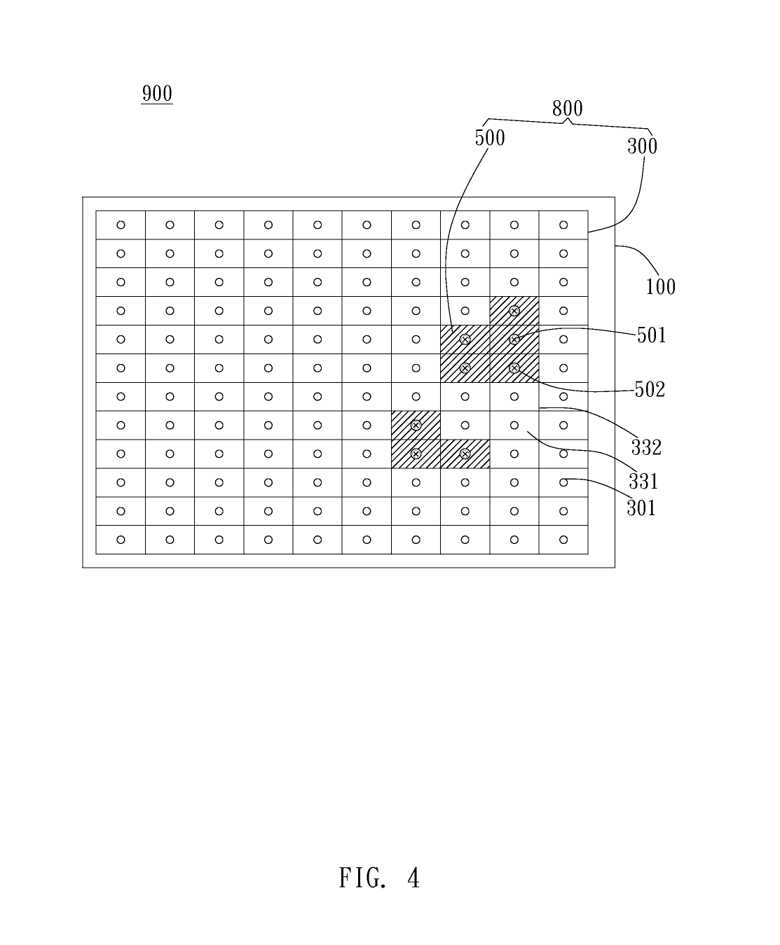

For example, compared with FIG. 3, the area of the predefined area 331 in FIG. 4 are reduced to increase the number of the predefined areas 331 for a given area of the balance plate 300. In this embodiment, the “accuracy” of balancing is increased due to the increased number of the predefined areas 331.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A weight balance module for use with a storage device, comprising:
a balance plate disposed on a bottom face of the storage device, wherein the balance plate has a plurality of predefined areas; and
at least one balance piece selectively disposed on one of the plurality of predefined areas.

2. The weight balance module of claim 1, wherein the balance plate are identical to the bottom face in shape and area, wherein the balance plate overlaps the bottom face.

3. The weight balance module of claim 1, wherein the balance plate has a plurality of partition lines for defining the plurality of predefined areas.

4. The weight balance module of claim 1, wherein the plurality of predefined areas are identical in shape and surface area.

5. The weight balance module of claim 4, wherein the balance piece has a cross section identical to each of the predefined areas in shape and surface area.

6. The weight balance module of claim 1, wherein each predefined area has a screw hole, the balance piece has a fixing hole, the balance piece is disposed on the predefined area by making a screw pass through the fixing hole and be screwed into the screw hole.

7. A gravity center adjustable storage device, comprising:
a storage device having a bottom face;
a balance plate disposed on the bottom face, wherein the balance plate has a plurality of predefined areas; and
at least one balance piece selectively disposed on one of the plurality of the predefined areas.

8. The gravity center adjustable storage device of claim 7, wherein the balance plate is identical to the bottom face in shape and area, wherein the balance plate overlaps the bottom face.

9. The gravity center adjustable storage device of claim 7, wherein the gravity center of the gravity center adjustable storage device is located on the central normal of the bottom face when the at least balance piece is disposed on at least one of the plurality of the predefined areas.

10. The gravity center adjustable storage device of claim 7, wherein the balance plate has a plurality of partition lines for defining the plurality of predefined areas.

11. The gravity center adjustable storage device of claim 7, wherein the plurality of predefined areas are identical in shape and surface area.

12. The gravity center adjustable storage device of claim 11, wherein the balance piece has a cross section identical to the predefined area in shape and area.

13. The gravity center adjustable storage device of claim 7, wherein each predefined area has a screw hole, the balance piece has a fixing hole, the balance is disposed on the predefined area by making a screw pass through the fixing hole and be screwed into the screw hole.
